(19) United States
(12) Patent Application Publication
(10) Pub. No.: US 2020/0223105 A1
(43) Pub. Date: Jul. 16, 2020

(54) METHOD FOR PROTOTYPING AND MANUFACTURING HIGH-CONTOUR STRUCTURES OF ORIENTED THERMOPLASTICS AND ORIENTED THERMOPLASTIC COMPOSITES

(71) Applicants: Mark V. Wasson, Billerica, MA (US); John R. Courter, Malden, MA (US); Anatol Kwartler, Maynard, MA (US)

(72) Inventors: Mark V. Wasson, Billerica, MA (US); John R. Courter, Malden, MA (US); Anatol Kwartler, Maynard, MA (US)

(21) Appl. No.: 16/248,673

(22) Filed: Jan. 15, 2019

(51) Int. Cl. B29C 33/38; B29C 33/42; B05D 1/10

(52) U.S. Cl. CPC B29C 33/3842; B05D 1/10; B29C 33/42

(57) ABSTRACT

A method for manufacturing high-contour structures by utilizing high pressure differential and applied consolidation temperatures, without the use of a heated press.

### FIELD OF THE INVENTION

A method for manufacturing high-contour structures by utilizing high pressure differential and applied consolidation temperatures, without the use of a heated press.

### BACKGROUND OF THE INVENTION

U.S. Pat. No. 5,182,155 relates to a radome structure providing high ballistic protection with low signal loss. The radome has a composite wall structure including alternating layers of polyethylene fiber laminating material which provides high ballistic protection with low signal loss and fiberglass honeycomb core material.

U.S. Pat. No. 7,681,485 relates to a laminated, optically transparent, ballistic resistant structure having a first transparent layer, a second transparent layer of ceramic tiles spread across the first layer, and a third transparent layer. The first and third layers are bonded to opposite sides of the second layer by transparent adhesive.

U.S. Pat. No. 7,688,278 relates to a ballistic protective radome consisting of longitudinal layer members densely packed in a uniform array forming a main protective layer. The layer members are electrically isolated such that a continuous gap is formed in the main protective layer. The layer members are made of mechanical energy absorbing and high tensile strength materials. The surface of the layer members is electrically conducting.

U.S. Pat. No. 8,054,239 relates to a honeycomb-backed armored radome. The radome is configured to extend over an opening of an antenna and includes a rigid layer underlying a ballistic-resistant layer. The rigid layer includes a honeycomb based material having a plurality of holes that extend transversely to the surface of the ballistic resistant layer.

U.S. Pat. No. 8,368,610 relates to a shaped ballistic radome that comprises a system for shielding transmission devices for ballistic deflection and protection of antenna equipment.

U.S. Pat. No. 8,599,095 relates to a broad band ballistic resistant radome. The invention relates to a radome cover for a RF sensor that comprises a first and second ballistic layer each having a ceramic layer. The two ballistic layers are sandwiched between at least two matching layers and the matching layers are impedance matched to the ceramic layers. The radome cover provides ballistic protection for the RF sensor.

U.S. Pat. No. 9,669,568 relates to a process for producing a three-dimensionally shaped article comprising: providing a structure containing a plurality of films or tapes of uni-directionally oriented polymer and forming the structure into a three-dimensionally shaped article by applying a force under the melting point of the oriented polymer. Shaped articles thus obtained are suitable for use as anti-ballistic articles.

U.S. Patent publication 2010/0166994 relates to a curved armor product. The armor product is produced by a filament winding process in which a plurality of reinforcing elements in the form of fibers or tapes are impregnated with a polymer matrix and wound onto a mandrel. The polymer matrix comprises a solution or dispersion of a polymer in a carrier fluid which is partly evaporated during winding. The armor product comprises a high amount of reinforcing elements with respect to the total mass of the product.

U.S. Patent publication 2011/0159233 relates to a process for manufacturing a curved product comprising positioning a plurality of drawn polymeric reinforcing elements onto a mandrel, adhering at least part of the elements to each other, and removing the product from the mandrel. The curved article is preferably an armor article which has good anti-ballistic properties and is substantially free from wrinkles.

U.S. Patent Publication 2014/0000796 relates to a curved armor product produced by a filament winding process in which a plurality of the reinforcing elements are in the form of fibers or tapes that are impregnated with a polymer matrix and wound onto a mandrel. The polymer matrix comprises a solution or dispersion of a polymer in a carrier fluid which is partly evaporated during or after winding. The armor product comprises a high amount of reinforcing elements with respect to the total mass of the product.

U.S. Patent Publication 2015/0033936 relates to composite panel comprising at least one layer containing at least one tape comprising a thermoplastic polymer selected from the group consisting of polyolefins, polyesters, polyvinyl alcohols, polyacrylonitriles, polyamides or polyketone, and an adhesive in contact with said layer, wherein the adhesive is a plastomer wherein said plastomer is a random copolymer of ethylene or propylene, the tape comprises an ultra-high molecular weight polyethylene. The composite panel is used in a ballistic resistant article.

U.S. Patent Publication 2016/0178327 relates to ballistic resistant sheets and articles such as curved ballistic resistant armor and helmets. The ballistic resistant sheets are a multi-layer monolayer construction including a core layer having first unidirectional oriented reinforcing fibers and an elastomeric material sandwiched between the face layers.

U.S. Patent Publication 2016/0380345 relates to composite anti-ballistic radome walls that have radar transparency properties and include an anti-ballistic internal solid, void-free core and external antireflective surface layers which sandwich the core.

### SUMMARY OF THE INVENTION

The present invention is a method for making three-dimensional high contour structures and shapes that do not have a draft angle, or can curve back upon themselves, made of linearly oriented thermoplastics. In addition to having the shapes and features, the created linearly oriented thermoplastic composite has properties and or features that facilitate structural attachment to create larger assemblies. The inherent properties of the structure can be rugged and able to resist projectiles, shrapnel, and over-pressure blasts.

The present invention relates to producing a rugged radome closure that has a spherical portion and a cylindrical portion with a joggle at the base. These features preclude pressing or filament winding manufacturing methods to manufacture ruggedized and ballistic protective closures, but are not limited to only the manufacturing method. It is an object of the invention for the method to be used for items that can also be filament wound or pressed. It is an object of the present invention for the joggle to be at 90°.

The present invention involves the fabrication processes by which rugged radome closures are fabricated of materials that are commonly applied to lightweight ballistic protection armor. These linearly oriented thermoplastic materials and the processes to convert them into radome shapes differ from conventional radome materials and associated fabrication processes.

The fabrication process utilized an autoclave or like process that contains the ply stack. The ply stack is laid up on a net shape tool. The two-dimensional material is darted and nested with many other layers that provide a near even thickness of linearly oriented thermoplastic material. This ply stack is then contained or isolated from the atmospheric air by a vacuum bag, flexible caul, inflatable mandrel or similar gas barrier. The autoclave or like process then reduces pressure within the ply stack relative to the pressure vessel atmosphere. This may be accomplished by applying vacuum to the stack or applying pressure to the pressure chamber environment, inflating a Blatter or mandrel, thus creating a pressure differential across the gas barrier. The vacuum bag or pressure isolation material does not necessarily have to be removable and can be ride-away tooling or an inner or outer coating.

It is an object of the present invention for common thermoplastics used in the present invention to be comprised of High Density Polyethylene, Ultra High Molecular Weight Polyethylene, Polypropylene, Aramid and any combination thereof.

It is an object of the present invention to produce complex curvature radome closures, the choice material fabric or tape is cut into unique two-dimensional (flat) shapes. The flat shapes are laid into a three dimensional mold to yield a desired near-net-shape three dimensional complex curvature radome closure after consolidation.

It is an object of the present invention for the consolidation of layers into a solid laminate to be accomplished by exposing the layers to pressure or a combination of pressure and temperature. The consolidation pressure may lie generated by compression molding, vacuum, a pressurized vessel, or similar method.

The present invention encompasses a rugged radome system that comprises a radome shell, an adhesive/sealant, a lower ring, an upper ring and a sealing gasket.

### BRIEF DESCRIPTION OF THE DRAWINGS

FIG. 1 shows a RCOTM workflow Diagram.

FIG. 2 shows a Manufacturing workflow Diagram.

FIG. 3 shows a three-dimensional high contour structure.

### DETAILED DESCRIPTION

FIG. 1 shows a flow chart wherein at first stage 10 a tool type is made of any shape and composed of any material. In second stage 20, the tool is contoured including any complex curvature and draft angles. In a preferred embodiment the curvature and draft angles are greater than 90°. In stage 30, a parent material comprised of plies of two dimensional linearly oriented thermoplastic is gored or cut to conform to the tool surface. In stage 40, the material is formed by having multiple layers of the linearly oriented thermoplastic stacked to mark the required composite structure. In Stage 50 there is consolidation where temperature is applied and consolidation is achieved utilizing a vacuum hag and pressure differential in an apparatus such as an autoclave.

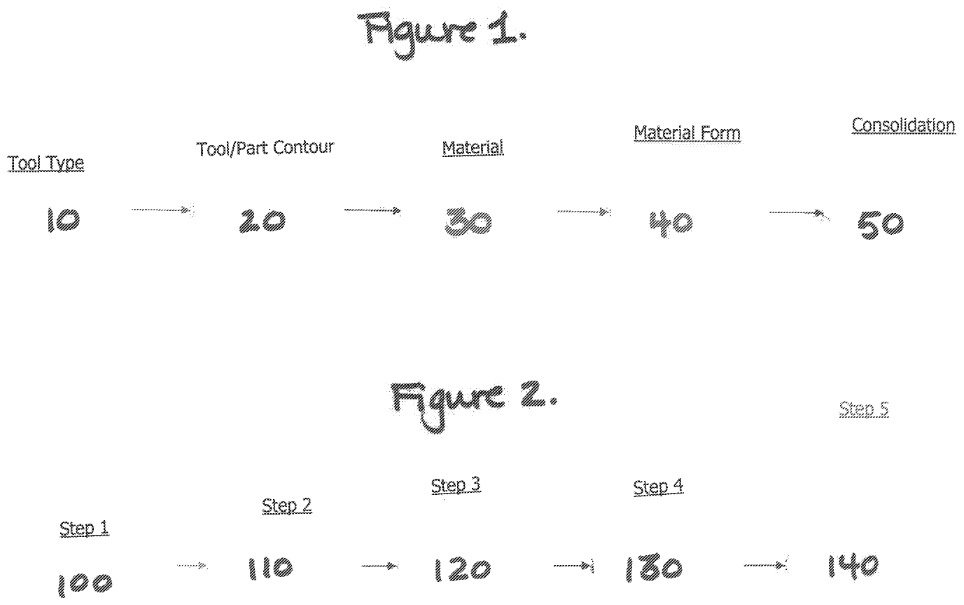

FIG. 2 shows a manufacturing workflow diagram where in Step 100 a tool is manufactured and/or prepped for layup. In Step 110 a two-dimensional material is cut to conform to a three-dimensional shape. Multiple patterns can be used. In Step 120, a two-dimensional material is laid up on a tool. Debulking and intermediate consolidations may be used to maintain part of the shape and contour. In Step 130, a vacuum bag or a gas barrier material is applied to isolate the composite stack from the local atmosphere. In Step 140, heat is applied and in the circumstance of an autoclave, vacuum is applied to the part or vented to the atmosphere while high pressure is accumulated in the local atmosphere to create a pressure differential that consolidates the composite stack against the tool surface.

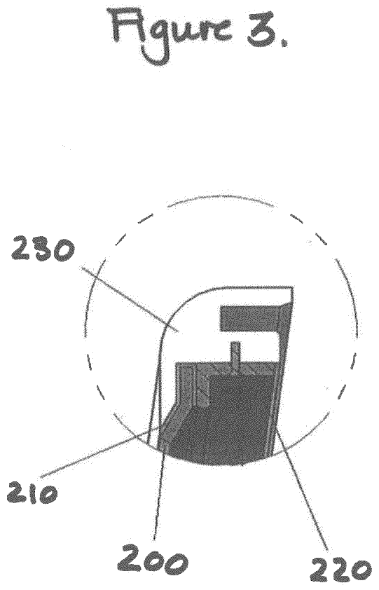

FIG. 3 shows a three-dimensional high contour structure that comprises a linearly oriented thermoplastic composite 200, a sealant/stress normalization layer 210, a segmented capture ring 220 and a continuous ring 230 for attachment to a larger assembly.

1. A method for making fully three-dimensional composite high contour structures and shapes comprising:
forming a composite having high contour shapes that do not have draft a angle, or curve back upon themselves;
said composite comprising linearly oriented thermoplastics;
said linearly oriented thermoplastic composite having properties or features for structural attachment to create larger assemblies;
said structure is rugged and resists projectiles, shrapnel, and pressure blasts.

2. A method for producing a rugged radome closure comprising:
forming a rugged radome closure that has a spherical portion and a cylindrical portion with a joggle at the base;
precluding pressing or filament winding manufacturing methods to manufacture ruggedized and ballistic protective closures;
providing ballistic protection;
fabricating said rugged radome closure out of materials that are applied to light-weight ballistic protection armor;
converting said materials into radome shapes.

3. The method of claim 2 wherein said fabrication process uses an autoclave or like process that contains ply stack;
said ply stack laid upon a net tool shape;
said ply stack darted and nested with other layers that provide a near even thickness of linearly oriented thermoplastic material.

4. The method of claim 2 wherein said method is used for items that are filament wound or pressed.

5. The method of claim 2 wherein said ply stack is contained or isolated from atmospheric air by a vacuum bag, flexible caul, inflatable mandrel or similar gas barrier.

6. The method of claim 5 wherein said autoclave or like process reduces pressure within said ply stack relative to pressure chamber atmosphere.

7. The method of claim 6 wherein said process is accomplished by applying vacuum to said stack or applying pressure to said pressure chamber atmosphere; inflating a Blatter or mandrel thus creating a pressure differential across gas barrier.

8. The method of claim 7 wherein said vacuum bag or pressure isolation material does not have to be removable and is ride-away tooling or an inner or outer coating.

9. The method of claim 2 wherein said thermoplastics comprise: High Density Polyethylene, Ultra High Molecular Weight Polyethylene, Polypropylene, Aramid or any combination thereof.

10. A method for producing complex curvature radome closures comprising:
cutting choice material fabric or tape into unique two-dimensional (flat) shapes;
laying said flat shapes into a three-dimensional mold to yield a desired near-net-shape three dimensional complex curvature radome closure after consolidation;
forming said consolidation of layers into a solid laminate by exposing said layers to pressure or a combination of pressure and temperature.

11. The method of claim 10 wherein said pressure is generated by compression molding, vacuum, a pressurized vessel or similar method.

12. A method of making a tool comprising:
providing a tool type of any shape and any material;
contouring said tool including any complex curvature and draft angles;
goring or cutting a parent material comprised of plies of two-dimensional linearly oriented thermoplastic to conform to said tool surface;
forming a material by having multiple layers of said linearly oriented thermoplastic stacked to mark required composite structure;
providing consolidation where temperature is applied utilizing a vacuum bag and pressure differential in an apparatus.

13. The method of claim 12 wherein said apparatus is an autoclave.

14. A method for manufacturing a tool comprising:
cutting a two-dimensional material to conform to a three-dimensional shape;
laying said two-dimensional material on said tool;
debulking and consolidating said material to maintain part of shape and contour of said tool;
applying a vacuum bag or gas barrier material to isolate said composite from local atmosphere;
applying heat, vacuum or combination of both to create pressure differential that consolidates said composite stack against tool surface.

15. The method of claim 14 wherein said vacuum is from an autoclave, applied to part or vented to atmosphere while high pressure is accumulated in local atmosphere.

16. The method of claim 2 wherein said joggle is 90°.

17. The method of claim 12 wherein said complex curvature and draft angles are greater than 90°.
